(19) United States
(12) Patent Application Publication
(10) Pub. No.: US 2021/0018327 A1
(43) Pub. Date: Jan. 21, 2021

(54) VEHICLE AND WEARABLE DEVICE OPERATION

(71) Applicant: Ford Global Technologies, LLC, Dearborn, MI (US)

(72) Inventors: Pramita MITRA, Bloomfield Hills, MI (US); Yifan CHEN, Ann Arbor, MI (US); Qianyi WANG, Allen Park, MI (US)

(21) Appl. No.: 16/482,789

(22) PCT Filed: Feb. 3, 2017
(86) PCT No.: PCT/US2017/016351

§ 371 Date: Aug. 1, 2019

(51) Int. Cl. G01C 21/36; G06F 1/16; B60K 35/00; B60K 15/03

(52) U.S. Cl. CPC G01C 21/362; G01C 21/3617; G01C 21/3697; G06F 1/163; B60K 2015/03217; B60K 15/03; B60K 2370/566; B60K 2370/573; B60K 2370/169; B60K 35/00

(57) ABSTRACT

An operation is identified with a first computer based on vehicle sensor data. A display item is presented on a display of a second computer that is a wearable device based on the operation.

### BACKGROUND

Vehicles such as passenger cars and the like typically include a human machine interface (HMI) via which occupants can monitor and/or control various vehicle operations. For example, a vehicle HMI typically includes a fixed screen mounted to a vehicle instrument panel and/or center console. Operations monitored or controlled by a vehicle HMI can include climate control, infotainment system control, indicating a destination, obtaining a route, and, in the case of an autonomous or semi-autonomous vehicle providing input to cause the vehicle to travel to a destination without, or with reduced, user input. However, current HMIs can be difficult to access and/or provide input to.

### BRIEF DESCRIPTION OF THE DRAWINGS

FIG. 1 is a block diagram of an example system for operating a wearable device.

FIG. 2 illustrates an example wearable device with a plurality of icons.

FIG. 3 illustrates the wearable device of FIG. 2 with the plurality of icons rotated based on data from a vehicle sensor.

FIG. 4 is a block diagram of an example process for displaying the icons on a wearable device.

### DETAILED DESCRIPTION

A user device can collect data from a vehicle sensor. The user device can predict an operation for user selection based on the data. The user device processor can instruct a wearable device to present an icon on a display of the wearable device based on the identified operation.

By presenting the icon based on the data from the vehicle sensor, the user device processor can enhance the efficiency and/or safety of operating a vehicle; the user device can cause to be presented on the wearable device display icons representing software applications and/or vehicle operations that are more likely useful to the user. That is, a user-desired operation can be predicted based on the data from the vehicle sensors, and the user device processor can then identify icons, e.g., for a software application, for an HMI interface representing an operation, etc., that may be presented for user selection during the operation. Using the data from the vehicle sensors can improve the likelihood that the user device processor can correctly predict performing user's desired operation, and can provide the user with an input mechanism, i.e., an icon or the like, that will allow the user to provide input so that the operation can be more efficiently and/or safely performed.

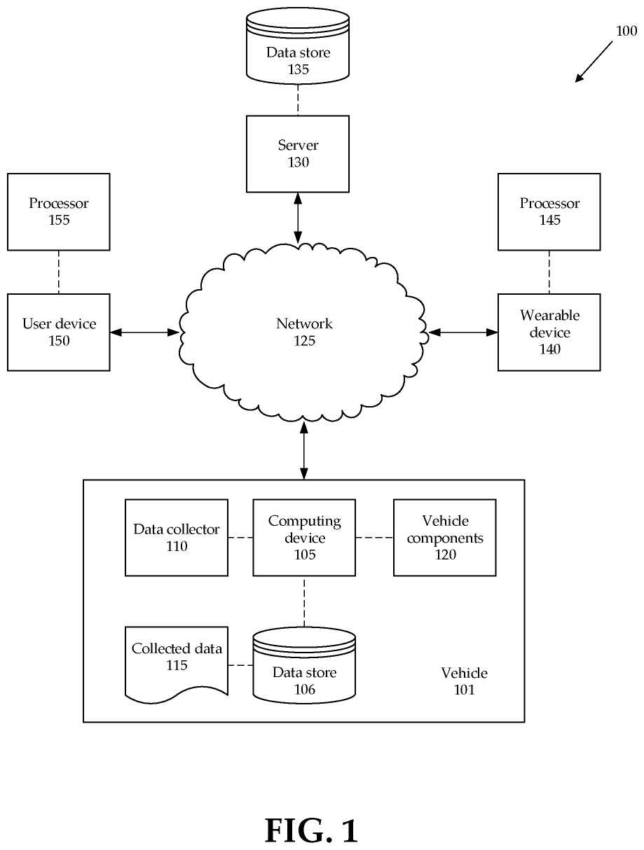

FIG. 1 illustrates a system 100 including a wearable device 140 communicatively coupled to a computing device 105 in a vehicle 101. The computing device 105 is programmed to receive collected data 115 from one or more sensors 110, e.g., vehicle 101 sensors, concerning various metrics related to the vehicle 101. For example, the metrics may include a velocity of the vehicle 101, vehicle 101 acceleration and/or deceleration, data related to vehicle 101 path or steering including lateral acceleration, curvature of the road, biometric data related to a vehicle 101 operator, e.g., heart rate, respiration, pupil dilation, body temperature, state of consciousness, etc. Further examples of such metrics may include measurements of vehicle systems and components (e.g. a steering system, a powertrain system, a brake system, internal sensing, external sensing, etc.). The computing device 105 may be programmed to collect data 115 from the vehicle 101 in which it is installed, sometimes referred to as a host vehicle 101, and/or may be programmed to collect data 115 about a second vehicle 101, e.g., a target vehicle.

The computing device 105 is generally programmed for communications on a controller area network (CAN) bus or the like. The computing device 105 may also have a connection to an onboard diagnostics connector (OBD II). Via the CAN bus, OBD II, and/or other wired or wireless mechanisms, the computing device 105 may transmit messages to various devices in a vehicle and/or receive messages from the various devices, e.g., controllers, actuators, sensors, etc., including sensors 110. Alternatively or additionally, in cases where the computing device 105 actually comprises multiple devices, the CAN bus or the like may be used for communications between devices represented as the computing device 105 in this disclosure. In addition, the computing device 105 may be programmed for communicating with the network 120, which, as described below, may include various wired and/or wireless networking technologies, e.g., cellular, Bluetooth®, wired and/or wireless packet networks, etc.

The data store 106 may be of any known type, e.g., hard disk drives, solid state drives, servers, or any volatile or non volatile media. The data store 106 may store the collected data 115 sent from the sensors 110.

Sensors 110 may include a variety of devices. For example, various controllers in a vehicle may operate as sensors 110 to provide data 115 via the CAN bus, e.g., data 115 relating to vehicle speed, acceleration, system and/or component functionality, etc., of any number of vehicles 101, including the host vehicle and/or the target vehicle. Further, sensors or the like, global positioning system (GPS) equipment, etc., could be included in a vehicle and configured as sensors 110 to provide data directly to the computer 105, e.g., via a wired or wireless connection. Sensors 110 could include mechanisms such as RADAR, LIDAR, sonar, etc. sensors that could be deployed to measure a distance between the vehicle 101 and other vehicles or objects. Yet other sensors 110 could include cameras, breathalyzers, motion detectors, etc., i.e., sensors 110 to provide data 115 for evaluating a condition or state of a vehicle 101 operator.

Collected data 115 may include a variety of data collected in a vehicle 101. Examples of collected data 115 are provided above, and moreover, data 115 is generally collected using one or more sensors 110, and may additionally include data calculated therefrom in the computer 105, and/or at the server 130. In general, collected data 115 may include any data that may be gathered by the sensors 110 and/or computed from such data.

The system 100 may further include a network 125 connected to a server 130 and a data store 135. The computing device 105 may further be programmed to communicate with one or more remote sites such as the server 130, via a network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, IEEE 802.11, etc.), local area networks (LAN) and/or wide area networks (WAN), including the Internet, providing data communication services.

The system 100 may include a wearable device 140. As used herein, a “wearable device” is a portable, computing device including a structure so as to be wearable on a person's body (e.g., as a watch or bracelet, as a pendant, etc.) that includes a memory, a processor, a display, and one or more input mechanisms, such as a touchscreen, buttons, etc., as well as hardware and software for wireless communications such as described herein. A wearable device 140 typically will be of a size and shape to be fitted to or worn on a person's body, e.g., a watch-like structure including bracelet straps, etc., and as such typically will have a smaller display than a user device 150, e.g., ⅓ or ¼ of the area. For example, the wearable device 140 may be a watch, a smart watch, a vibrating apparatus, etc. that includes capabilities for wireless communications using IEEE 802.11, Bluetooth®, and/or cellular communications protocols. Further, the wearable device 140 may use such communications capabilities to communicate via the network 125 and also directly with a vehicle computer 105, e.g., using Bluetooth®. The wearable device 140 includes a wearable device processor 145. The wearable device 140 can include one or more sensors 110 to collect data 115. For example, the wearable device 140 can include a sensor 110 to collect biometric data 115, e.g., a heart rate, a skin galvanic response, etc. The wearable device processor 145 can send the data 115 to the computing device 105 and/or the user device processor 155 over the network 125. The wearable device processor 145 can use the collected data 115 to, e.g., adjust icons on a display of the wearable device 140.

The system 100 may include a user device 150. As used herein, a “user device” is a portable, non-wearable computing device that includes a memory, a processor, a display, and one or more input mechanisms, such as a touchscreen, buttons, etc., as well as hardware and software for wireless communications such as described herein. That the user device 150 is “non-wearable” means that it is not provided with any structure to be worn on a person's body; for example, a smart phone user device 150 is not of a size or shape to be fitted to a person's body and typically must be carried in a pocket or handbag, and could be worn on a person's body only if it were fitted with a special case, e.g., having an attachment to loop through a person's belt, and hence the smart phone user device 150 is non-wearable. Accordingly, the user device 150 may be any one of a variety of computing devices including a processor and a memory, e.g., a smartphone, a tablet, a personal digital assistant, etc. the user device 150 may use the network 125 to communicate with the vehicle computer 105 and the wearable device 140. For example, the user device 150 and wearable device 140 can be communicatively coupled to each other and/or to the vehicle computer 105 with wireless technologies such as described above. The user device 150 includes a user device processor 155. The user device 150 can include one or more sensors 110 to collect data 115. The user device processor 155 can send the data 115 to the computing device 105 and/or the wearable device processor 145 over the network 125. The user device processor 155 can use the collected data 115 to, e.g., adjust icons on a user device 150 display.

The wearable device processor 145 and the user device processor 155 can instruct the computing device 105 to actuate the components 120. A user can provide an input to an icon on a wearable device display 160. Based on the user input, the wearable device processor 145 can instruct the user device processor 155 and/or the computing device 105 to actuate the components 120 associated with the input.

The user device processor 155 can use data 115 from one or more sensors 110 in the vehicle 101 and/or the wearable device 140 to determine an operation that the user is about to perform. In this context, to “determine” an operation means to predict, based on data 115, an operation. Further, as used herein, an “operation” is an action or a plurality of actions that a vehicle 101 and/or one or more components 120 thereof could perform based on input from the user device 150 and/or wearable device 140. A predicted operation is on that the user is likely to select based on the data 115. Example operations include, but are not limited to, purchase fuel, purchasing food and beverages, adjusting an entertainment system, moving to a specific destination, adjusting a climate control system, etc. For example, data 115 regarding locations of the vehicle 101, location of the user, status of vehicle 101 components 120, and the times corresponding to the locations can indicate what the user did at the locations. The user device processor 155 can determine the operation performed at the locations, e.g., if the data 115 from a fuel level sensor 110 indicates that the fuel level of the vehicle 101 rises at a certain time, the user device processor 155 can determine that the operation is purchasing fuel and filling the fuel tank. The user device processor 155 can, based on the operation, instruct the wearable device processor 145 to provide a notification on the wearable device display 160 related to the operation, e.g., providing directions to a fuel station when the fuel level sensor 110 determines that the fuel level drops below a threshold. The threshold can be determined by comparing the fuel level data 115 from previous times when the fuel level rose, i.e., determining the fuel level prior to the user purchasing fuel. The user device processor 155 can identify a plurality of user operations based on the data 115.

In addition to actuating one or more components 120, the user device processor 155 and/or the wearable device processor 145 can, based on the user operation, actuate one or more components in the user device 150 and/or the wearable device 140. For example, the wearable device processor 145 can change an arrangement of icons on the wearable device display 160. In another example, the user device processor 155 can send a notification over the network 125 to another person indicating the location of the vehicle 101 and the user. In another example, the user device processor 155 can select one or more notifications to be displayed on the wearable device display 160 and select one or more notifications to be hidden when the user device processor 155 determines that the vehicle 101 is in motion to, e.g., reduce a likelihood of distraction of the user from the notifications.

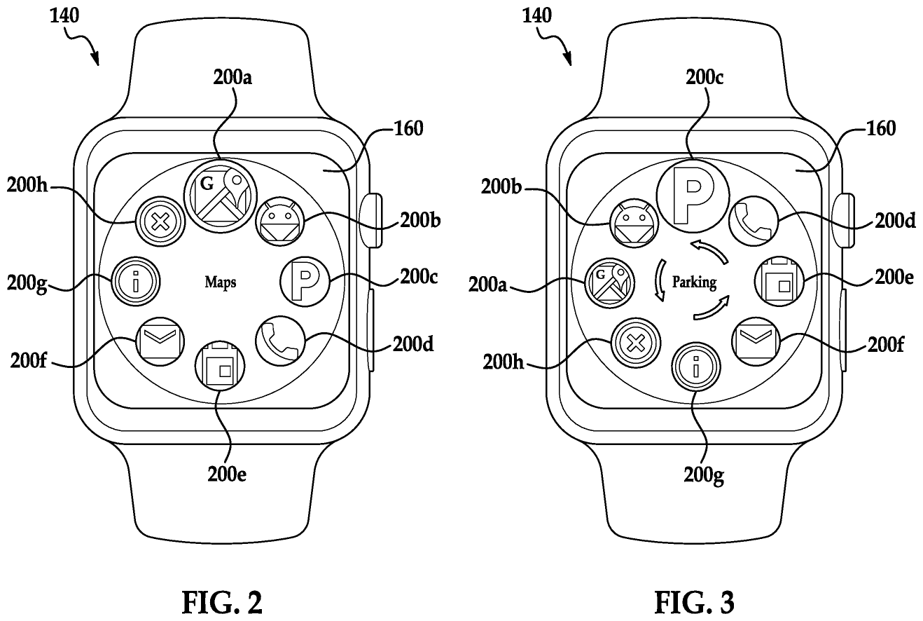

FIG. 2 illustrates an example wearable device 140. The wearable device 140 has a wearable device display 160. The wearable device display 160 can be a touchscreen display that can receive inputs from the user, e.g., a tactile input. The wearable device display 160 can display images and text for the user.

The wearable device processor 145 can be programmed to display a plurality of icons 200 on the wearable device display 160. The icons 200 are images that indicate locations on the wearable device display 160 for the user to provide input. Upon providing input to one of the icons 200, the wearable device processor 145 can be programmed to, e.g., run a software application. FIG. 2 illustrates 8 icons 200a, 200b, 200c, 200d, 200e, 200f, 200g, 200h, and each of the icons 200a-200h is associated with a specific software application. For example, the icon 200a can be associated with a navigation application. In another example, the icon 200c can be associated with a parking application. In another example, the icon 200f can be associated with a text messaging application.

The user device processor 155 can instruct the wearable device processor 145 to present one or more icons 200 on the wearable device display 160 based on one or more identified operations. As used herein, the wearable device processor 145 “presents” the icon 200 when the wearable device processor 145 displays the icon 200 on the wearable device display 160. For example, if the user device processor 155 determines that the operation is purchasing fuel, the user device processor 155 can instruct the wearable device processor 145 to display an icon 200 for a fuel station rewards application, a fuel price aggregator, a navigation application with predetermined locations of nearby fuel stations, etc. In another example, the user device processor 155 can compare the collected data 115 to a predetermined route selected by the user (e.g., in a navigation application), and to present additional icons 200 on the wearable device display 160 based on the predetermined route, e.g., an icon 200 for a fuel station near the route (i.e., a fuel station notification), an icon 200 for a coffee shop near the route, etc. The user device processor 155 can be programmed to identify a plurality of operations and to instruct the wearable device processor 145 to present a respective icon 200 for each of the user operations.

Based on the operation, the user device processor 155 can instruct the wearable device processor 145 to present one of the icons 200 on the wearable device display 160 for the user. For example, if the identified operation is navigating the vehicle 101, the user device processor 155 can instruct the wearable device processor 145 to display the icon 200a near a top of the wearable device display 160 and/or to increase a size of the icon 200a. By moving the icon 200a near the top of the wearable device display 160 and increasing the size of the icon 200a, the user is more likely to notice the icon 200a and provide input to the icon 200a.

Based on the data 115, the user device processor 155 can determine that one of the previously determined operations is complete, i.e., is no longer an operation. For example, if the operation is purchasing fuel, the user device processor 155 can determine the operation is complete upon receiving data 115 from a fuel sensor 110 indicating that the fuel level is above a fuel level threshold. Upon determining that one of the operations is complete, the user device processor 155 can instruct the wearable device processor 145 to remove the respective icon 200 for the completed operation.

FIG. 3 illustrates the wearable device processor 145 having adjusted the wearable device display 160 to show a different arrangement of icons 200 from the arrangement shown in FIG. 2. As the user device processor 155 collects data 115 from the sensors 110 in the vehicle 101, the user device processor 155 can determine that the user's desired operation has changed. For example, if the data 115 from a fuel level sensor 110 indicates that the fuel level has increased, the user device processor 155 can determine that purchasing fuel is no longer the current operation and can determine a new operation for the user.

In the example of FIG. 3, the user device processor 155 instructs the wearable device processor 145 to rotate the icons 200a-200h so that the parking icon 200c (which was at the three o'clock position in FIG. 2) is near the top of the wearable device display 160, e.g., at the twelve o'clock position. The user device processor 155 can, additionally or alternatively, increase the size of the icon 200c and decrease the size of the icon 200a, as shown in FIG. 3. That is, in the example of FIG. 3, the user device processor 155 determines that the user operation is parking the vehicle 101, and instructs the wearable device processor 145 to present the icon 200c on the wearable device display 160. As the user device processor 155 collects more data 115, the user device processor 155 can update the determined operation and instruct the wearable device processor 145 to present other icons 200 according to the determined operation.

The user device processor 155 and/or the wearable device processor 145 can be programmed to determine a display item for the determined user operation. In the examples provided below, the system 100 is described such that the user device processor 155 is programmed to determine the display item for the determined user operation. Alternatively or additionally, the wearable device processor 145 can be programmed to perform at least some steps in addition to or in lieu of the user device processor 155. A “display item” in the context of this disclosure is an icon representing a software application and/or process (collectively, software application), or is a message or set of data displayed to a user, e.g., “fuel station in 1 mile,” etc. Icon 200 display items represent software applications or the like to which the user device processor 155 can direct the user to complete the identified user operation. For example, if the user operation is purchasing fuel, the software application can be a gas station price aggregator. The user device processor 155 can identify the software application based on a user history. That is, the user device processor 155 can identify software applications used by the user during previous operations to identify one or more software applications for the current operation. For example, the user device processor 155 can identify that, in prior instances of the fuel purchasing operation, the user used the wearable device 140 to use a navigation application to locate a gas station. Based on the user history, the user device processor 155 can identify, for the fuel purchasing operation, to present the icon 200 for the navigation software application on the wearable device display 160. Alternatively or additionally, the user device processor 155 can identify the display item based on, e.g., a predetermined display item from the data store 106 and/or the server 130.

The user device processor 155 can be programmed to instruct the wearable device processor 145 to display a notification on the wearable device display 160 based on the operation. The notification can provide information to the user associated with the operation and/or the solution to the operation. For example, if the user device processor 155 identifies the operation as purchasing fuel, the user device processor 155 can instruct the wearable device processor 145 to display a text notification indicating a current fuel level, a location of a nearby fuel station, and an estimated price of fuel at the fuel station. In another example, the user device processor 155 can instruct the wearable device processor 145 to display a calendar entry indicating an appointment on the wearable device display 160.

The user device processor 155 can use the data 115 from the sensors 110 (e.g., sensors 110 in the vehicle 101 and/or sensors 110 in the wearable device 140 and/or sensors in the user device 150) to select the display items presented on the wearable device display 160. For example, the user device processor 155 can receive information from the server 130 regarding traffic data to estimate an arrival time from a current location of the vehicle 101 to a destination. The user device processor 155 then determines a walking time from the user's current location and the current location of the vehicle 101 and adds the walking time to the arrival time. The user device processor 155 then receives data 115 from a fuel level sensor 110 in the vehicle 101. If the data 115 indicate that the vehicle 101 will not reach the destination at the current fuel level, the user device processor 155 can display a notification on the wearable device display 160 indicating that the fuel level is low and/or could display an icon 200 for locating a gas station. The user device processor 155 can instruct the wearable device processor 145 to present a list of nearby gas stations on the wearable device display and/or the vehicle 101 display. The list of nearby gas stations can include gas stations previously visited by the vehicle 101 and stored on the server 130. The user device processor 155 can then receive weather information from the server 130 and adjust the arrival time to the destination according to the weather information.

In another example, the user device processor 155 identifies a person attending the meeting, i.e., a meeting attendant, from a contact list from a meeting listed in a calendar. The user device processor 155 can prepare a notification to the meeting attendant with an arrival time of the user based on the traffic data, the fuel sensor data, etc. The user device processor 155 can adjust the arrival time and send a notification to the meeting attendant with an updated arrival time based on information from the vehicle sensors 110. The user device processor 155 can present a display item to send the notification to the meeting attendant as an icon 200 on the wearable device display 160. When the user provides an input to the wearable device display 160, the user device processor 155 can send the notification to the meeting attendant over the network 125.

In another example, the user device processor 155 can predict an upcoming destination and plot a route to the predicted destination. The user device processor 155 can compare destinations and times of day associated with the destinations in a user drive history. Based on the destinations and times of day, the user device processor 155 can prepare a route to a predicted destination based on the time of day. The user device processor 155 can further use a calendar date, traffic data 115, and weather data 115 to predict the destination. The user device processor 155 can present a display item on the wearable device display 160 with navigation instructions to the destination. Upon receiving input to the wearable device display 160, the user device processor 155 can instruct the computing device 105 to actuate components 120 to present the navigation instructions on, e.g., a vehicle 101 display.

In another example, the user device processor 155 can add icons 200 to the wearable device display 160 while the user is on the route. The user device processor 155 can identify locations along the route and applications associated with the locations, e.g., coffee shops, car repair, gas stations, etc. When the vehicle 101 approaches the locations, the user device processor 155 can add one or more icons 200, and when the vehicle 101 passes the locations, the wearable device 145 can remove one or more icons 200. The user device processor 155 can measure biometric data 115 of the user, e.g., heart rate, perspiration, etc. Based on the biometric data 115, the user device processor 155 can add one or more icons 200. For example, if the heart rate of the user slows, the user may be tired, and the user device processor 155 can add icons 200 related to entertainment selection.

In another example, the user device processor 155 can provide walking directions to the user based on location data 115 of the user, the parked vehicle 101, and the destination. Upon determining the route, prior to embarking on the route, the user device processor 155 can compare the location of the user and the location of the vehicle 101 and generate walking directions from the location of the user to the vehicle 101. Then, upon reaching the vehicle 101, the user device processor 155 can determine driving directions and present them on the vehicle 101 HMI. Then, upon parking the vehicle 101, the user device processor 155 can determine walking directions from the vehicle 101 to the destination.

In another example, the user device processor 155 selectively present notifications on the wearable device display 160 to reduce the number of notifications for the user to address. The user device processor 155 can develop a user history of notifications that are dismissed by the user and notification that are read by the user. Furthermore, the user device processor 155 can record a time indicating when the user read the notification, i.e., a timestamp. The user device processor 155 can use the recorded timestamps and the current time to present notifications that have timestamps within a time threshold of the current time. The user device processor 155 can hide notifications that are dismissed by the user and/or have timestamps that are not within the time threshold of the current time.

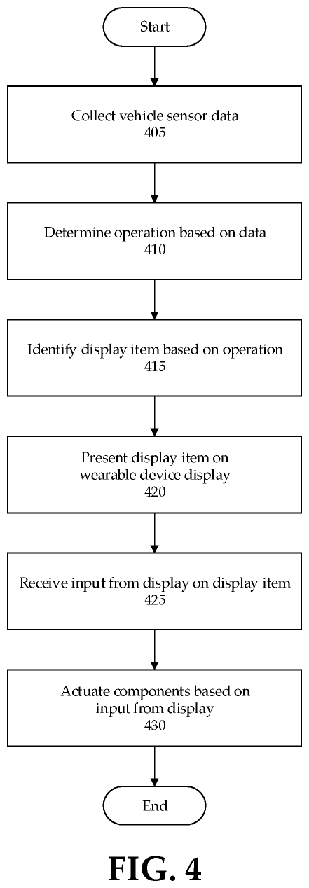

FIG. 4 illustrates an example process 400 for selecting icons 200 to display on a wearable device display 160. The process 400 starts in a block 405, in which the user device processor 155 collects data 115 from sensors 110 in the vehicle 101 and/or the wearable device 140. The user device processor 155 can request the data 115 from the computing device 105. Alternatively or additionally, the wearable device processor 145 can collect the data 115 from the vehicle 101 sensors 110. Furthermore, while the process 400 is described below as performed by the user device processor 155, the process 400 can be performed at least partly by the wearable device processor 145. That is, the steps of the process 400 can be performed in one or both of the user device processor 155 and/or the wearable device processor 145.

Next, in a block 410, the user device processor 155 determines a user operation based on the data 115. As described above, the data 115 can indicate that the user is performing one or more operations, and the user device processor 155 can determine the current user operation based on the most recently collected data 115.

Next, in a block 415, the user device processor 155 identifies a display item for the determined operation. The display item can be determined based on a user history. That is, based on data 115 collected from prior instances of the current operation, the user device processor 155 can develop a user history for the operation. Based on the user history, the user device processor 155 can identify solution software application or the like and/or data for the operation. For example, if the operation is moving to a destination, the user device processor 155 can identify a navigation application with directions to the destination for the determined operation. Alternatively, the user device processor 155 can identify the display item without the user history and on some other basis. For example, the user device processor 155 can be programmed to identify the display item for the determined operation based on a predetermined display item associated with the operation stored in the data store 106 and/or the server 130.

Next, in a block 420, the user device processor 155 instructs the wearable device processor 145 to present a display item, i.e., an icon 200 (i.e., representing a software application or the like for user selection) and/or data on the wearable device display 160 based on the determined operation. For example, the user device processor 155 can instruct the wearable device processor 145 to present the icon 200 for the navigation application on the wearable device display 160.

Next, in a block 425, the user device processor 155 detects an input from the user on the wearable device display 160. The input can indicate that the user wants to actuate the software application and/or the vehicle component 120 associated with one of the icons 200 on the wearable device display 160. For example, the user can provide input to the wearable device display 160 on the icon 200 for the navigation application with directions to the destination.

Next, in a block 430, the user device processor 155 instructs the computing device 105 to actuate one or more vehicle components 120 based on the icon 200 selected on the wearable device display 160. For example, if the user provided input on the navigation application icon 200, the user device processor 155 can instruct the computing device 105 to actuate the propulsion 120, the steering wheel 120, and the brake 120 to move the vehicle 101 to the destination. Following the block 430, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, sensor measurements, computations, processing time, communications time, etc.

Computing devices 105 generally each include instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computing device 105 is generally a collection of data stored on a computer readable medium, such as a storage medium, a random access memory, etc.

A computer readable medium includes any medium that participates in providing data (e.g., instructions), which may be read by a computer. Such a medium may take many forms, including, but not limited to, non volatile media, volatile media, etc. Non volatile media include, for example, optical or magnetic disks and other persistent memory. Volatile media include dynamic random access memory (DRAM), which typically constitutes a main memory. Common forms of computer readable media include, for example, a floppy disk, a flexible disk, hard disk, magnetic tape, any other magnetic medium, a CD ROM, DVD, any other optical medium, punch cards, paper tape, any other physical medium with patterns of holes, a RAM, a PROM, an EPROM, a FLASH EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

1. A system, comprising a first computer programmed to:
identify an operation based on vehicle sensor data; and
based on the operation, present a display item on a display of a second computer that is a wearable device.

2. The system of claim 1, wherein the first computer is further programmed to actuate one or more vehicle components based on input to the display item.

3. The system of claim 1, wherein the first computer is further programmed to identify the operation based on a history of use of the wearable device.

4. The system of claim 1, wherein the first computer is further programmed to compare the sensor data to a predetermined route, and to present a second display item to the wearable device based on the predetermined route.

5. The system of claim 1, wherein the first computer is further programmed to determine that the operation is complete and to remove display item from the display of the wearable device.

6. The system of claim 1, wherein the display item is a notification based on the operation.

7. The system of claim 1, wherein the first computer is further programmed to identify a plurality of operations and to present a respective display item for each of the operations and to remove the respective display item when the operation is complete.

8. The system of claim 1, wherein the first computer is further programmed to identify the operation based on a user location.

9. The system of claim 1, wherein the first computer is further programmed to collect data from a vehicle fuel level sensor; wherein the display item is a fuel station notification.

10. The system of claim 1, wherein the first computer is further programmed to collect data from a wearable device sensor and to identify the operation based on the data from the vehicle sensor and the wearable device sensor.

11. A method, comprising:
identifying an operation with a first computer based on vehicle sensor data; and
based on the operation, presenting a display item on a display of a second computer that is a wearable device.

12. The method of claim 11, further comprising actuating one or more vehicle components with the first computer based on input to the display item.

13. The method of claim 11, further comprising identifying the operation based on a history of use of the wearable device.

14. The method of claim 11, further comprising comparing the sensor data to a predetermined route and presenting a second display item to the display of the wearable device based on the predetermined route.

15. The method of claim 11, further comprising determining that the operation is complete and removing the display item from the display of the wearable device.

16. The method of claim 11, wherein the display item is a notification based on the operation.

17. The method of claim 11, further comprising identifying a plurality of operations and presenting a respective display item for each of the operations and removing the respective display item when the operation is complete.

18. The method of claim 11, further comprising identifying the operation based on a user location.

19. The method of claim 11, further comprising collecting data from a vehicle fuel level sensor; wherein the display item is a fuel station notification.

20. The method of claim 11, further comprising collecting data from a wearable device sensor and identifying the operation based on the data from the vehicle sensor and the wearable device sensor.
